(19) United States
(12) Patent Application Publication
(10) Pub. No.: US 2026/0187685 A1
(43) Pub. Date: Jul. 2, 2026

(54) SYSTEMS AND METHODS FOR EFFICIENT DETERMINATION OF MULTI PAYER ELIGIBILITY

(71) Applicant: OPTUM, INC., Minnetonka, MN (US)

(72) Inventors: Madhavi Ginjupalli, Edison, NJ (US); Ahmed E. Habib, Corcoran, MN (US); Muneeruddin Nizamuddin, Hyderabad (IN); Vartika Sanat, Uttar Pradesh (IN); Karthikkumar R. Iyengar, Round Rock, TX (US); Hitesh K. Singh, Delhi (IN); Siji Sivadasank, Telengana (IN)

(21) Appl. No.: 19/006,577

(22) Filed: Dec. 31, 2024

(51) Int. Cl. G06Q 30/0282; G06Q 40/08

(52) U.S. Cl. CPC G06Q 30/0282; G06Q 40/08

(57) ABSTRACT

The present disclosure generally relates to multiple payer eligibility determinations, and more particularly, to using machine learning (ML) to predict payer lists and rankings for members. A first ML component determines/predicts/infers that a set of member identifiers, from among multiple such identifiers included in membership data of various coverage providers, is associated with a particular member. A second ML component determines a ranked coverage provider set associated with the member. The second ML component may estimate a relationship between interdependent variables, such as claims, enrollment, eligibility, and plan details, for example.

### TECHNICAL FIELD

The present disclosure generally relates to multiple payer eligibility determinations, and more particularly, to using machine learning (ML) to predict payer lists and rankings for members.

### BACKGROUND

Eligibility determination is an important prerequisite for most healthcare deliveries. The need for eligibility determination remains irrespective of the underlying rules that may vary based on the insurance plan and enrollment. Eligibility determination workflows include multiple actors and multiple events. In a member's healthcare journey, there are multiple touchpoints when eligibility verification occurs.

Many members are covered with more than one insurance plan from multiple coverage providers, e.g., payers, because of multiple benefits like volunteer benefits, dual special needs plans (DSNP), or coverage through spouse health benefits. Healthcare enrollment and eligibility research data for the United States shows that, on average, a member is associated with five to seven coverage providers in his or her lifetime. The relationship ranking between the coverage providers and the member might change year over year. In other words, it is likely that a secondary/tertiary coverage provider will become a primary coverage provider in the future. This multi-coverage-provider eligibility determination makes the eligibility checks, verification process, and coordination of benefits more complex than a single coverage provider situation. Multiple queries that consume a large amount of time, effort, and computing resources are required to determine the full eligibility of a member, resulting in inconsistent eligibility determination responses, member and medical provider dissatisfaction, increased administrative cost for coverage providers and medical providers, and additional processor and network usage.

Accordingly, a need exists for processing techniques that determine eligibility among multiple coverage providers in an efficient and accurate manner.

### BRIEF DESCRIPTION OF THE DRAWINGS

The figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present techniques are implemented, according to one aspect.

FIG. 2 depicts an example data processing process for member identity unification data, according to one aspect.

FIG. 3 depicts an example ML training and testing architecture for training and/or testing one or more ML member ID unification components, according to one aspect.

FIG. 4 depicts an example ML operating process for processing member and/or claims data using an ML member ID unification component, according to one aspect.

FIG. 5 depicts an example data processing flow for coverage provider ranking data, according to one aspect.

FIG. 6 depicts an example ML training and testing data flow in which a coverage provider ranking ML component may be trained and/or tested, according to one aspect.

FIG. 7 depicts an example ML operation data flow in which a coverage provider ranking ML component may generate coverage provider ranking predictions, according to one aspect.

FIG. 8 depicts an example method for generating coverage provider rankings, according to one aspect.

### DETAILED DESCRIPTION

### Introduction

The techniques disclosed herein efficiently and accurately assess coverage eligibility for a member associated with multiple coverage providers (e.g., insurers/payers). The disclosed techniques use a first machine learning (ML) component to determine, predict, or infer that a set of member identifiers, from among multiple such identifiers included in membership data of various coverage providers, is associated with a particular member. The membership data may include, for example, various types of membership information (e.g., name, age, gender, address, medical history details, etc.) associated with different member identifiers that may or may not be associated with the particular member. As used herein, the phrases “membership data” and “membership information” may refer to categories of data objects stored on or retrieved from at least one computer-readable medium. The disclosed techniques then associate a unified global identifier with the set of member identifiers (each associated with the particular member). The unified global identifier is then used to generate a longitudinal dataset that comprises the membership information specifically associated with the set of member identifiers for the particular member. The disclosed techniques use a second ML component to determine, based on the longitudinal dataset input, a ranked coverage provider set associated with the member. The second ML component may estimate one or more relationships between interdependent variables, such as claims, enrollment, eligibility, and plan details, for example.

Advantageously, the disclosed methods, systems, and media provide improvements in computer functionality. Relative to existing techniques that require multiple queries/searches to determine the information of a member across different coverage providers, and thus coverage eligibility (or potential eligibility) for the member, the disclosed techniques identify a common member identity (represented by the unified global identifier) from among multiple, inconsistent member identifiers. The unified global identifier may then be used to determine related information such as multi-coverage provider eligibility in a manner that is faster and more computationally efficient than multiple searches for each of the multiple member identifiers associated with the common identity. For example, the disclosed methods, systems, and media access a longitudinal dataset, generated from consolidated data sources with the aid of the first ML component, to uniquely identify a member across multiple insurance providers (e.g., in a single query/search), which reduces processor and network usage.

As is clear from the above and the description that follows, the present disclosure provides specific features that are not well-understood, routine, or conventional activity in the field (e.g., using ML to uniquely identify members and predict rankings of multiple coverage providers). Other advantages will also be apparent to those of ordinary skill in the relevant art upon reviewing this disclosure.

### Example Computing System

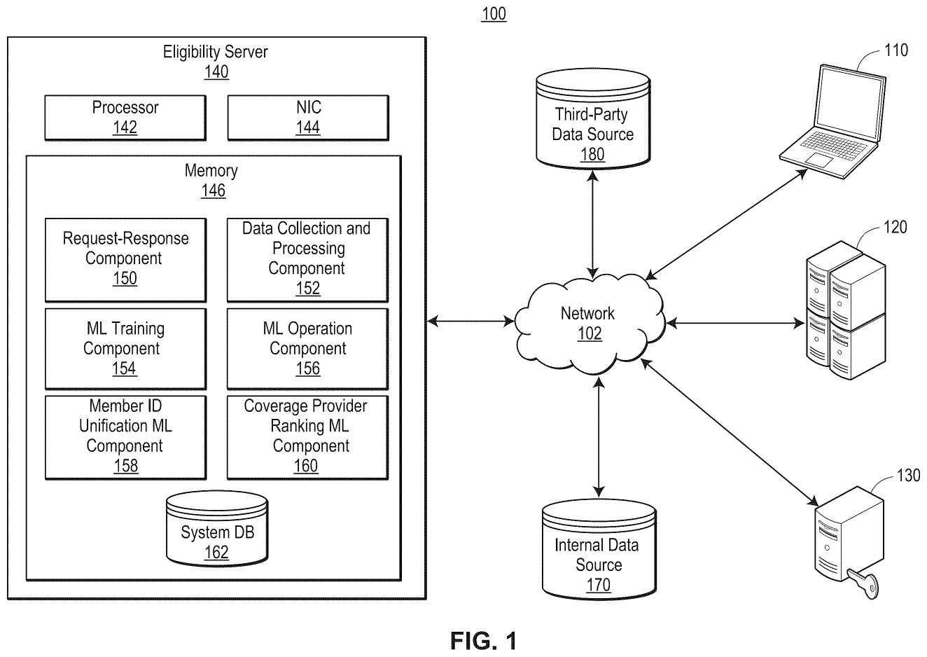

FIG. 1 depicts an example computing system 100 in which various embodiments of the present disclosure may be implemented. Although FIG. 1 depicts certain entities, components, equipment, and devices, it should be appreciated that additional or alternate entities, components, equipment, and devices are also possible. In some embodiments, the example computing system 100 identifies members across multiple coverage provider systems and/or identifies and ranks multiple coverage providers for a member. Of course, it should be appreciated that, while the various components of the example computing system 100 (e.g., network 102, client device 110, application server 120, authentication server 130, eligibility server 140, internal data source 170, third-party data source 180, etc.) are illustrated in FIG. 1 as single components, the example computing system 100 may include a plurality of application servers 120, authentication servers 130, eligibility servers 140, internal data sources 170, and/or third-party data sources 180. In some embodiments, one or more components of the computing system 100 (e.g., network 102, client device 110, application server 120, authentication server 130, eligibility server 140, internal data source 170, third-party data source 180, etc.) are located in a remote data center, such as a cloud computing environment.

The network 102 connecting these components includes one or more communication networks of one or more types, such as local area networks (LANs), wide area networks (WANs) like the Internet, wired, and/or wireless, or a combination thereof. In one embodiment, for example, the network 102 includes a wireless cellular network (e.g., 4G, 5G, 6G, etc.). Generally, the network 102 enables bidirectional communication between the client device 110, application server 120, authentication server 130, eligibility server 140, internal data source 170, and third-party data source 180.

In one embodiment, the network 102 comprises one or more cellular base stations, such as cell tower(s), communicating with one or more other components of the example computing system 100 via wired/wireless communications based upon any one or more of various wireless communication standards, including NMT, GSM, CDMA, UMTS, LTE, 5G, 6G, or the like. Additionally or alternatively, the network 102 may comprise one or more routers, wireless switches, and/or other nodes communicating with the components of the example computing system 100 based upon any one or more of various other wireless and/or wired communications standards, including by non-limiting example, IEEE 802.11a/ac/ax/b/c/g/n (Wi-Fi®), Bluetooth®, Ethernet, and/or the like.

The client device 110 performs at least some of the functionalities and techniques disclosed herein. In some embodiments, the client device 110 includes one or more computing devices (e.g., desktop computer, laptop computer, terminal), mobile devices, wearables, smart watches, smart contact lenses, smart glasses, augmented reality (AR) glasses/headsets, virtual reality (VR) glasses/headsets, mixed or extended reality glasses/headsets, and/or other suitable electronic or electrical components. The client device 110 includes a memory and a processor for, respectively, storing and executing one or more software components, such as a web browser, computer-executable instructions, operating systems, etc. In some embodiments, the memory includes one or more suitable storage media such as a magnetic storage device, a solid-state drive, random access memory (RAM), and/or any other type of volatile or non-volatile memory. The client device 110 includes an input/output device, which includes a display (dedicated or touchscreen). The input/output device is configured to present graphical user interfaces (GUIs) and/or other information for presentation to a user and/or receive input from the user. The client device 110 includes a network interface controller (NIC), which accesses services or other functionalities and/or components of the example computing system 100 (e.g., application server 120) via the network 102. In some embodiments, the example computing system 100 includes multiple client devices similar to the client device 110.

The memory of the client device 110 stores an application, which is generally used to request or receive information/data from, and/or provide information/data to, the application server 120. In some embodiments, the application includes a web browser, a client application, and/or a mobile application. The application includes a GUI for presenting controls and information on the input/output device. In one embodiment, the client device 110 is associated with a coverage provider. In another embodiment, the client device 110 is associated with a medical provider or member (e.g., if members can directly check their coverage/eligibility).

The application server 120, the authentication server 130, and the eligibility server 140 perform at least some of the functionalities and techniques disclosed herein. In one embodiment, the application server 120, the authentication server 130, and/or the eligibility server 140 are operated by or on behalf of a coverage provider. The application server 120, the authentication server 130, and the eligibility server 140 can each encompass single servers, or multiple servers that are co-located or remotely distributed. The application server 120, the authentication server 130, and/or the eligibility server 140 may be part of a cloud network or may otherwise communicate with other hardware and/or software components within one or more cloud computing environments to send, retrieve, or otherwise analyze data or information described herein. In some example embodiments, the application server 120, the authentication server 130, and/or the eligibility server 140 comprise, or exist within, an on-premises computing environment, a multi-cloud computing environment, a public cloud computing environment, a private cloud computing environment, and/or a hybrid cloud computing environment.

The eligibility server 140 includes a processor 142, which may include any number of processors and/or processor types, such as central processing units (CPUs), graphics processing units (GPUs), one or more tensor processing units (TPUs), one or more field-programmable gate arrays (FPGAs), one or more application-specific integrated circuits (ASICs), and/or the like. The processor 142 is communicatively coupled to a memory 146, e.g., via a computer bus, such that the processor 142 can execute machine-readable instructions stored in memory 146 to perform operations disclosed herein. The application server 120 and authentication server 130 may have respective processors similar to processor 142.

The eligibility server 140 includes a network interface controller (NIC) 144, which may include any suitable network interface controller(s) and facilitates communication over the network 102 between the eligibility server 140 and other components of the example computing system 100. The NIC 144 includes hardware and/or software that operates in accordance with at least one communication protocol of the network 102. The NIC 144 communicates via any suitable wired and/or wireless connection (e.g., according to any of the wired or wireless protocols/standards discussed above for network 102). The application server 120 and authentication server 130 may have respective NICs similar to NIC 144.

The eligibility server 140 includes a memory 146. The memory 146 may include volatile and/or non-volatile memory, such as read-only memory (ROM), electronic programmable read-only memory (EPROM), erasable electronic programmable read-only memory (EEPROM), random access memory (RAM), hard drives, solid state drives, flash memory, MicroSD cards, and/or other type(s) of memory. The memory 146 may also store an operating system (e.g., Microsoft Windows, Linux, UNIX, etc.) capable of facilitating the functionalities, applications, methods, or other software as discussed herein. In some embodiments, the memory 146 stores one or more software components including respective sets of computer-executable instructions. The software components may be implemented in any desired programming language, and may be implemented as machine code, assembly code, byte code, interpretable source code, or the like (e.g., via Python, C, C++, Java, JavaScript, etc.). The application server 120 and authentication server 130 may have respective memories similar to memory 146.

In one embodiment, the application server 120 includes a software component for eligibility verification. The eligibility verification software component may provide eligibility verification for one or more of the following scenarios: a member scheduling a physician appointment; the member wanting to know an out-of-pocket cost; a medical provider needing to know at the time of delivering the service to ensure he or she will be paid later; a coverage provider ensuring right amount is paid per claim; care advocates suggesting to the member which care program to be enrolled for better care and/or lower cost; clearinghouses correctly allocating charges to the corresponding careers; utilization management programs performing prior authorization and referral management; Centers for Medicare & Medicaid Services (CMS) and the Federal Government verifying the claims data for Risk Adjustment programs; and collateralized debt obligations (CDOs) negotiating capitation fees.

In one embodiment, the authentication server 130 includes a software component for authenticating users. The user authentication software component may receive user credentials and/or a user access token via the application server 120. After authenticating the user, the user authentication software component may generate and send to the application server 120 an application access token.

In one embodiment, the eligibility server 140 includes the following software components: request-response component 150, data collection and processing component 152, ML training component 154, ML operation component 156, member identity (ID) unification ML component 158, coverage provider ranking ML component 160, and system database 162. In some embodiments, the software components of eligibility server 140 may be divided between or among a plurality of servers, e.g., the ML training component 154 may be located on a separate server.

In one embodiment, the eligibility server 140 includes a request-response component 150. The request-response component 150 may receive requests for member eligibility and/or coverage provider responsibility from the application server 120 and provide responses to the requests. The request-response component 150 may enable the eligibility server 140 to communicate with the application server 120 via an application programming interface (API).

In one embodiment, the eligibility server 140 includes a data collection and processing component 152. The data collection and processing component 152 may retrieve data from the internal data source 170 and/or the third-party data source 180. The data collection and processing component 152 may enable the eligibility server 140 to communicate with the internal data source 170 and/or the third-party data source 180 via an API. The data collection and processing component 152 may retrieve historical and/or current information about one or more members, coverage providers, and/or medical providers.

In one embodiment, the eligibility server 140 includes an ML training component 154. The ML training component 154 may train and/or validate one or more ML components, such as the member identity unification ML component 158 and the coverage provider ranking ML component 160. In various embodiments, the ML training component 154 employs various training techniques, such as supervised learning, unsupervised learning, and reinforcement learning.

In one embodiment, the ML training component 154 employs supervised learning, which involves identifying patterns in existing data to make predictions about subsequently received data. Specifically, an ML component may be “trained” (e.g., via ML training component 154) using training data, which includes example inputs and associated example outputs. Based upon the training data, the ML training component 154 may generate a predictive function, which maps outputs to inputs and may utilize the predictive function to generate ML outputs based upon data inputs. In the exemplary embodiments, an ML component may be trained by providing it with a large sample of data with known characteristics or features.

In another embodiment, the ML training component 154 employs unsupervised learning, which involves finding meaningful relationships in unorganized data. Unlike supervised learning, unsupervised learning does not involve user-initiated training based upon example inputs with associated outputs. Instead, in unsupervised learning, the ML training component 154 may organize unlabeled data according to a relationship determined by at least one ML method/algorithm.

In yet another embodiment, the ML training component 154 employs reinforcement learning, which involves optimizing outputs based upon feedback from a reward signal. Specifically, the ML training component 154 may receive a user-defined reward signal definition, receive a data input, utilize a decision-making component to generate the ML output based upon the data input, receive a reward signal based upon the reward signal definition and the ML output, and alter the decision-making component to receive a stronger reward signal for subsequently generated ML outputs. Other types of ML learning may also be employed, including deep or combined learning techniques.

The ML training component 154 may receive labeled data at an input layer of an ML component having a networked layer architecture (e.g., an artificial neural network, a convolutional neural network, etc.) for training the one or more ML components. The received data may be propagated through one or more connected deep layers of the ML component to establish weights of one or more nodes, or neurons, of the respective layers. Initially, the weights may be initialized to random values, and one or more suitable activation functions may be chosen for the training process. The present techniques may include training a respective output layer of the one or more ML components.

In operation, ML training component 154 may access the system database 162, the internal data source 170, the third-party data source 180, or any other data source for training data suitable to generate one or more ML components that make the predictions disclosed herein. The training data may be sample data with assigned relevant and comprehensive labels (classes or tags) used to fit the parameters (weights) of an ML component with the goal of training it by example. In one aspect, training data may include actual member claims, member demographics, eligibility data, etc.

In one embodiment, the eligibility server 140 includes an ML operation component 156. The ML operation component 156 may execute one or more ML components, such as the member identity unification ML component 158 and the coverage provider ranking ML component 160, by providing one or more data inputs to the ML component and receiving a prediction or response from the ML component. The ML operation component 156 may comprise a set of computer-executable instructions implementing ML loading, configuration, initialization, and/or operation functionality. The ML operation component 156 may include instructions for storing trained ML components (e.g., in the system database 162). In one aspect, once an appropriate ML component is trained and validated to provide accurate predictions and/or responses, the trained ML component may be loaded into ML operation component 156 at runtime, may process the inputs and/or prompts, and may generate as an output a prediction or response.

In one embodiment, the eligibility server 140 includes a member identity unification ML component 158. The member identity unification ML component 158 implements one or more ML-based algorithms to tie disparate membership records together to uniquely identify a member across data domains and/or multiple coverage providers. The one or more ML-based algorithms may include a neural network, deep learning component, Transformer-based component, generative pretrained transformer (GPT), generative adversarial network (GAN), regression component, k-nearest neighbor algorithm, support vector regression algorithm, decision tree, isolation forests, random forest algorithm, and/or Monte Carlo simulation, although any type of applicable ML-based algorithm may be used. In one aspect, the ML-based algorithms may be included as a library or package executed on the eligibility server 140. For example, libraries may include the TensorFlow-based library, the PyTorch library, the HuggingFace library, and/or the scikit-learn Python library.

In one embodiment, the eligibility server 140 includes a coverage provider ranking ML component 160. The coverage provider ranking ML component 160 implements one or more ML-based algorithms to predict a ranking, e.g., primary, secondary, and tertiary, among multiple coverage providers associated with a member. The one or more ML-based algorithms may include a neural network, deep learning component, Transformer-based component, generative pretrained transformer (GPT), generative adversarial network (GAN), regression component, k-nearest neighbor algorithm, support vector regression algorithm, linear regression, Bayesian linear regression, Bayesian Neural Network, isolation forests, random forest algorithm, and/or Monte Carlo simulation, although any type of applicable ML-based algorithm may be used.

In one embodiment, the eligibility server 140 includes or has access to a system database 162. One or more of the above-noted software components may store and/or retrieve information from the system database 162. The system database 162 may include a relational database, (such as Oracle®, IBM DB2®, or MySQL), a NoSQL based database (such as MongoDB), a vector database (such as Microsoft Azure Cosmos DB® or Pinecone), and/or a graph database (such as Neo4j), for example.

In one embodiment, the internal data source 170 includes one or more web servers, file servers, database servers, or any other suitable information storage servers. The internal data source 170 generally stores membership, claims, and/or eligibility information. The internal data source 170 may include a relational database, a NoSQL based database, a vector database, and/or a graph database, for example. The internal data source 170 may be owned or operated by the owner or operator of the eligibility server 140, such as a coverage provider.

In one embodiment, the third-party data source 180 includes one or more web servers, file servers, database servers, or any other suitable information storage servers. The third-party data source 180 generally stores membership, claims, eligibility, and/or medical records information. The internal data source 170 may include a relational database,, a NoSQL based database, a vector database, and/or a graph database, for example. The third-party data source 180 may be owned or operated by a third-party coverage provider or a medical provider.

### Example Process for Member Identity Unification Data

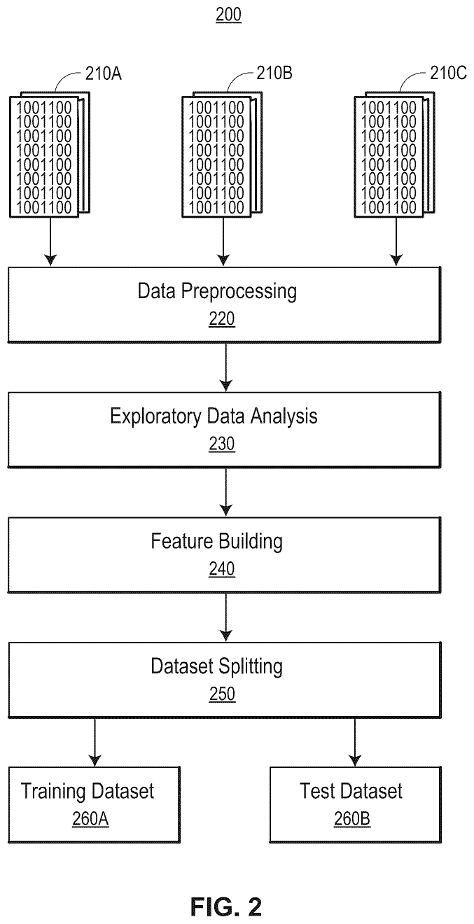

FIG. 2 depicts an example process 200 in which membership data may be processed. Although FIG. 2 depicts certain processes and data, it should be appreciated that additional or alternate processes and data are also possible. Some of the blocks in FIG. 2 represent processing stages (e.g., blocks 220-250), some blocks represent input data (e.g., blocks 210A-210C), and other blocks represent output data (e.g., blocks 260A and 260B). Input and output signals are represented by arrows. The data collection and processing component 152 may perform one, some, or all of the processing stages of the process 200.

In one aspect, the example process 200 includes a raw data collection comprising member claims data 210A, member eligibility data 210B, and/or member other data 210C. In some embodiments, the data collection and processing component 152 may collect the member claims data 210A, member eligibility data 210B, and/or member other data 210C from one or more of the system database 162, internal data source 170, and the third-party data source 180.

In one aspect, the example process 200 includes a data preprocessing stage 220. The data preprocessing stage 220 may preprocess the member claims data 210A, member eligibility data 210B, and/or member other data 210C. The data preprocessing stage 220 may include cleansing, removing duplicate values, imputing missing values, and any other suitable preprocessing action. The data preprocessing stage 220 may include labeling the member claims data 210A, member eligibility data 210B, and/or member other data 210C.

In one aspect, the example process 200 includes an exploratory data analysis stage 230. The exploratory data analysis stage 230 may include calculating the mean, median, standard deviation, minimum, maximum, and/or quartiles for one or more numerical values, such as age, claim amount, etc., in the data 210A-210C. Some embodiments of the exploratory data analysis stage 230 may include a similarity search on data sources such as longitudinal dataset 510 (explained below). The similarity search may include measures and techniques such as Manhattan Distance. Exploratory data analysis may include calculating metrics such as mean, median, standard deviation, minimum, maximum, and/or quartiles for one or more data categories, such as age or claim amount, in input data such as 210A-210C. Some embodiments of exploratory data analysis step 230 may use augmented search generation and may include detection of outliers. The exploratory data analysis stage 230 may include detecting outliers. The exploratory data analysis stage 230 may include normalizing the one or more numerical values. The exploratory data analysis stage 230 may include generating an address score associated with the similarity of two addresses. The exploratory data analysis stage 230 may include a name distance score associated with the similarity of the names of members. The exploratory data analysis stage 230 may include presenting visualizations, such as histograms or scatter plots, of the data 210A-210C and/or performing correlation analysis to determine relationships between different variables in the data 210A-210C. The exploratory data analysis stage 230 may include generating a relationship matrix that displays correlation coefficients between variables in the data 210A-210C.

In one aspect, the example process 200 includes performing a feature building stage 240. The feature building stage 240 may include feature transformation, such as encoding categorical features and scaling features. The feature building stage may include feature construction, such as creating new features out of existing features. The feature building stage 240 may include selection of the most relevant or important features. The feature building stage 240 may include extracting features, such as applying principal component analysis (PCA) or term frequency-inverse document frequency (TF-IDF) to text data. The feature building stage 240 may include labeling records with a ground truth member identity.

In one aspect, the example process 200 includes performing a data splitting stage 250. The data splitting stage 250 may include splitting the data into a training dataset 260A and a test dataset 260B. In some embodiments, the training and testing stage 260A and 260B may include differential privacy technique(s) that mask sensitive information (e.g., identity of members), such as by adding noise or randomness to the members longitudinal data. The data splitting stage 250 may split the data using k-fold cross-validation. The data collection and processing component 152 may store the training dataset 260A and the test dataset 260B in the system database 162 or another suitable location.

### Example ML Training and Testing Architecture for Member ID Unification ML Components

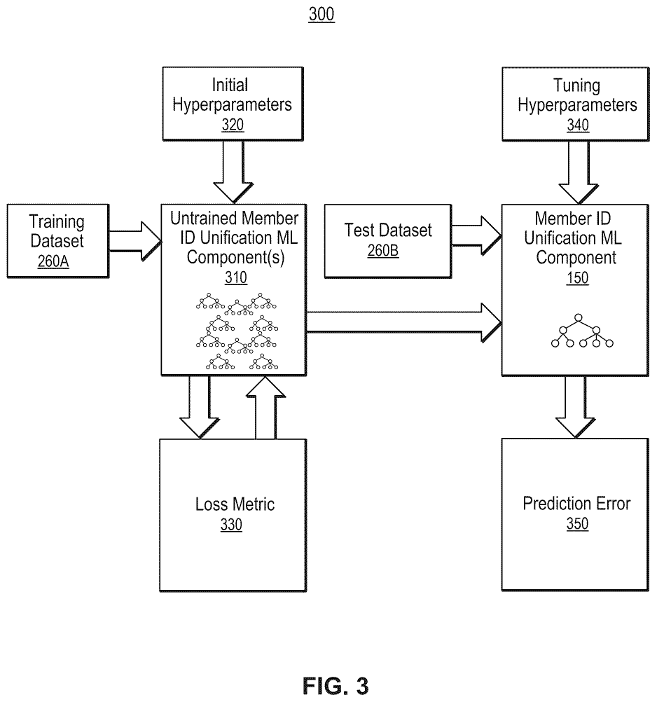

FIG. 3 depicts an example ML training and testing architecture 300 in which a member identity (ID) unification ML component (158) may be trained and/or tested. Although FIG. 3 depicts certain entities, components, equipment, and devices, it should be appreciated that additional or alternate entities, components, equipment, and devices are also possible. ML components, such as ML training component 154, may include one or more hardware and/or software components to obtain, create, (re)train, test, and/or save a number of features, such as samples per split, maximum tree depth, minimum sample split, maximum terminal nodes, and/or minimum samples per leaf for one or more ML components.

In some embodiments, there may be one or more untrained member ID unification ML components 310. The one or more untrained member ID unification ML components 310 may include one or more classification ML algorithms, such as decision trees, gradient boosting, and/or random forests.

In some embodiments, a user may configure the one or more untrained member ID unification ML components 310 with a set of initial hyperparameters 320. For a decision tree classification component, for example, the set of initial hyperparameters 320 may include specified values for the number of features sampled per split, maximum tree depth, minimum sample split, maximum terminal nodes, and/or minimum samples per leaf.

As described herein, a server, such as the eligibility server 140, may have available the training dataset 260A (e.g., stored in system database 162). In some embodiments, the training dataset 260A includes ground truth labels to aid in training and/or retraining the one or more untrained member ID unification ML components 310. The ML training component 154 may retrieve the training dataset 260A and train the one or more untrained member ID unification ML components 310.

In some embodiments, the ML training component 154 determines a loss metric 330 by comparing the predicted member identity classifications, e.g., same individual or different individual, generated by the one or more untrained member ID unification ML components 310 to the ground truth classifications in the training dataset 260A. For example, the ML training component 154 may apply zero-one, Gini impurity, and/or entropy to determine the loss metric 330. The ML training component 154 may use the loss metric to adjust the features and/or thresholds for one or more decision nodes in the decision tree.

In some embodiments, the ML training component 154 may train the one or more untrained member ID unification ML components 310 for a specified number of epochs, until a specified tree depth or node count is reached, or until the loss metric 330 reaches a specified value. The ML training component 154 may select the best performing component, e.g., lowest loss, of the one or more untrained member ID unification ML components 310 as the member ID unification ML component 158.

In some embodiments, the ML training component 154 may test and/or tune the member ID unification ML component 158. In some embodiments, the member ID unification ML component 158 may be tuned with a set of tuning hyperparameters 340, such as the number of features sampled per split, maximum tree depth, minimum sample split, maximum terminal nodes, and/or minimum samples per leaf.

As described herein, a server, such as the eligibility server 140, may have available the test dataset 260B (e.g., stored in system database 162). In an aspect, the test dataset 260B may labeled to aid in testing and/or tuning the member ID unification ML component 158. The ML training component 154 may retrieve the test dataset 260B and test and/or tune the member ID unification ML component 158.

In some embodiments, the ML training component 154 determines a prediction error 350 by comparing the predicted member identity classifications, e.g., same individual or different individual, generated by the member ID unification ML component 158 to the ground truth classifications in the test dataset 260B. For example, the ML training component 154 may calculate accuracy, true positive rate, false positive rate, precision, and/or F1 score to determine the prediction error 350. The ML training component 154 may use the loss metric to adjust the tuning hyperparameters 340.

### Example ML Training and Testing Data Flow for Member ID Unification ML Components

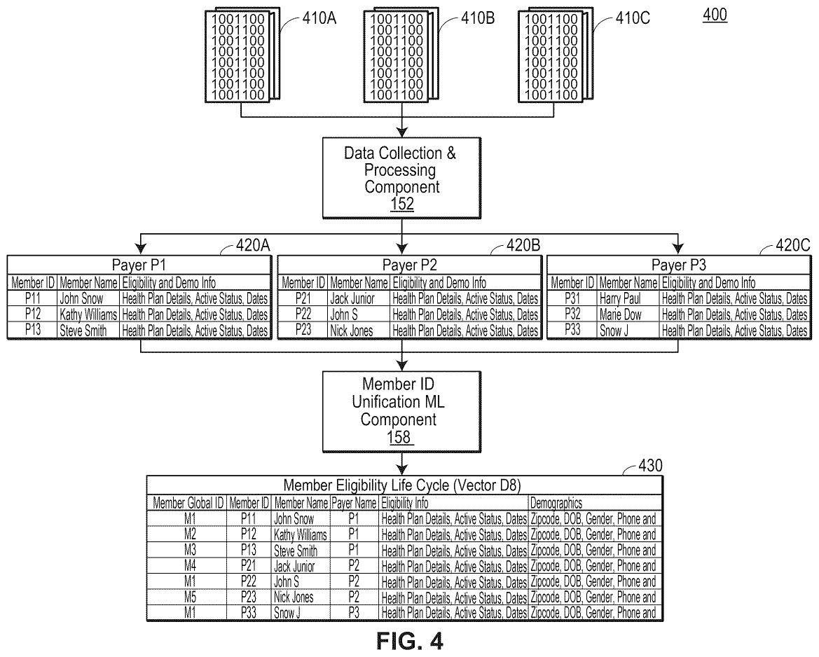

FIG. 4 depicts an example ML operating data flow 400 in which the trained member identity (ID) unification ML component 158 may operate. Although FIG. 4 depicts certain entities, components, equipment, and devices, it should be appreciated that additional or alternate entities, components, equipment, and devices are also possible.

In one aspect, the example ML operating data flow 400 includes a data collection comprising raw member claims data 410A, raw member eligibility data 410B, and/or raw member other data 410C. The raw member claims data 410A, raw member eligibility data 410B, and/or raw member other data 410C may include data from multiple coverage providers and/or other suitable data sources. In some embodiments, the data collection and processing component 152 may collect the raw member claims data 410A, raw member eligibility data 410B, and/or raw member other data 410C from one or more of the system database 162, internal data source 170, and the third-party data source 180. In some embodiments, the data collection and processing component 152 may process the raw member claims data 410A, raw member eligibility data 410B, and/or raw member other data 410C into a plurality of payer data tables, e.g., payer one data 420A, payer two data 420B, and payer three data 420C. As used herein, the phrase “coverage provider” may refer to a data object stored on or retrieved from at least one computer-readable medium that, through attributes of the data object or association with other data objects, may be determined to be of a category of data objects respectively identifying coverage providers or other categories of data.

In one aspect, the ML operation component 156 provides the plurality of payer data tables 420A-420C as input to the member ID unification ML component 158. The member ID unification ML component 158 may predict that different member IDs across multiple coverage providers are associated with the same individual. For example, the member ID unification ML component 158 may predict that member ID “P11” and member name “John Snow” in payer one data 420A, member ID “P22” and member name “John S” in payer two data 420B, and member ID “P33” and member name “Snow J” in payer three data 420C all correspond to the same member. As such, the member identity ID unification ML component 158 may generate a unified global identifier (ID), e.g., “M1,” that associates member IDs “P11,” “P22,” and “P33.” The member ID unification ML component 158 may output, a member eligibility lifecycle table 430. The member eligibility lifecycle table 430 may include member global ID, member IDs, member name, payer name, eligibility information, demographics, and/or other suitable fields for one or more members.

### Example Data Processing Flow for Coverage Provider Ranking Data

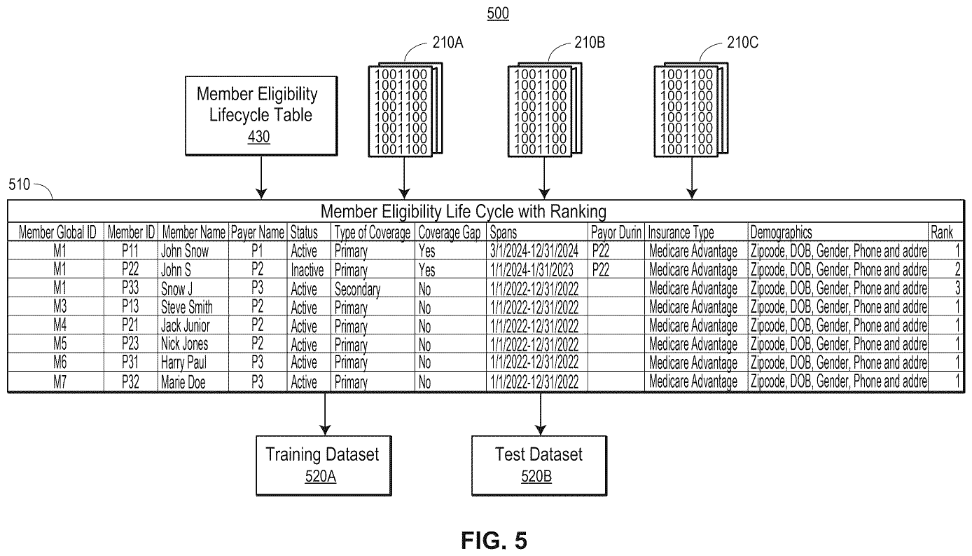

FIG. 5 depicts an example data processing flow 500 in which coverage provider data may be processed. Although FIG. 5 depicts certain processes and data, it should be appreciated that additional or alternate processes and data are also possible. Some of the blocks in FIG. 5 represent input data (e.g., blocks 210A-210C and 430), and other blocks represent output data (e.g., block 510). Input and output signals are represented by arrows. The data collection and processing component 152 may perform one or more of the processing steps.

In one aspect, the example data processing flow 500 includes the member claims data 210A, the member eligibility data 210B, the member other data 210C, and/or member eligibility lifecycle table 430. In some embodiments, the data collection and processing component 152 may collect the member claims data 210A, member eligibility data 210B, member other data 210C, and/or member eligibility lifecycle table 430 from one or more of the system database 162, internal data source 170, and the third-party data source 180.

In some embodiments, the data collection and processing component 152 may join a plurality of fields from the member claims data 210A, the member eligibility data 210B, the member other data 210C, and/or member eligibility lifecycle table 430 to generate a longitudinal dataset 510. The longitudinal dataset 510 may include one or more coverage providers for a member. The longitudinal dataset 510 may include the member global ID, the member IDs, the member name, member demographics, claim IDs, primary coverage provider ID, secondary coverage provider IDs, policy status, policy effective dates, insurance type, type of coverage, coverage gap, claim dates, payment status, service details, and/or any other suitable fields. In some embodiments, the records of the longitudinal dataset 510 may be labeled with ground truth coverage provider rankings.

In some embodiments, the data collection and processing component 152 may split the longitudinal dataset 510 into a training dataset 520A and a test dataset 520B. The data collection and processing component 152 may split the longitudinal dataset 510 using k-fold cross-validation. The data collection and processing component 152 may store the training dataset 520A and the test dataset 520B in the system database 162 or another suitable location.

### Example Ml Training and Testing Data Flow for Coverage Provider Ranking Prediction

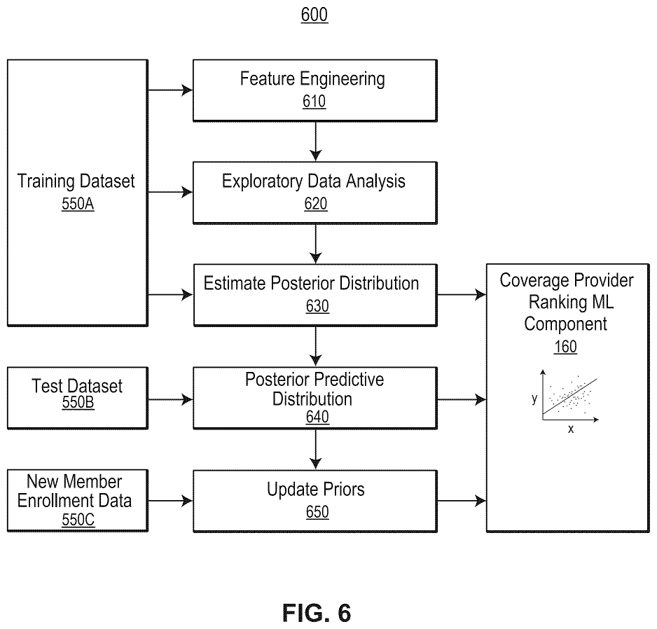

FIG. 6 depicts an example ML training and testing data flow 600 in which coverage provider ranking ML component 160 may be trained and/or tested. In the example ML training and testing data flow 600, training and testing a Bayesian linear regression and/or Bayesian Neural component is illustrated, although other suitable ML components may be used instead. In some embodiments, for training and testing data flow 600, a Bayesian Neural Network may be used. Although FIG. 6 depicts certain entities, components, equipment, and devices, it should be appreciated that additional or alternate entities, components, equipment, and devices are also possible. For example, the example ML training and testing data flow 600 may include differential privacy technique(s) that mask sensitive information (e.g., identity of members), such as by adding noise or randomness to the training datasets 550A and 550B. ML components, such as ML training component 154, may include one or more hardware and/or software components to obtain, create, (re)train, test, and/or save a number of features.

Linear regression takes the general form y=(β₀+β₁x₁+β₂x₂+ . . . +βₙxₙ)+ε, or y=β^{T}X+ε, where y is the response variable, xᵢ are the input variables, β₀ is the intercept, βᵢ are the associated coefficients, and ε is statistical noise. A Bayesian Neural Network takes the general form y=f(X; W)+ε, where y is the response variable, X are the input variables, W are the weight distributions, f is the neural network function parameterized by W, and ε is statistical noise.

Bayes' theorem states that the posterior is equal to the likelihood multiplied by the prior divided by the evidence, where likelihood quantifies how probable is the occurrence of observed data given specific parameter values, prior refers to assumptions about a parameter before observing any data, and posterior refers to an updated representation of assumptions after incorporating new evidence. Eliminating the evidence, which may be intractable to calculate, from the equation, the posterior is approximately equal to the likelihood times the prior. For Bayesian linear regression, P(β|X, y) is approximately P(X, y|β) P(β). Because X is constant and does not depend on β, the likelihood can be rewritten as P(y|β). Thus, the response variable, y, is approximately equal to N(β^{T}X+ε, σ²), where N is the number of samples and σ² is the variance. A Bayesian Neural Network, P(W|X, y) is approximately P(y|X, W) P(W). Because X is constant and does not depend on W, the likelihood can be rewritten as P(y|W). Thus, the response variable, y, is approximately equal to N(f(X; W), σ²), where f is the neural network function parameterized by the weight distributions W, N is the number of samples, and σ² is the variance. In Bayesian Neural Networks, the weights W are treated as probability distributions, and the response variable y is modeled as a normal distribution with mean f(X; W) and variance σ².

Markov Chain Monte Carlo (MCMC) methods, such as Gibbs sampling or the Metropolis-Hastings algorithm, are methods for estimating the posterior distribution of model parameters. These MCMC methods involve simulating a sequence of parameter values from the posterior distribution using random sampling. Over time, this sequence converges to approximate the true posterior distribution.

In one aspect, the ML training component 154 performs feature engineering 610 on the training dataset 510A. Feature engineering 610 may include univariate and/or bivariate and/or multivariate analysis of the training dataset 510A. Feature engineering 610 may include analyzing the central tendency, outliers, and/or dispersions of variables in the training dataset 510A. Feature engineering 610 may include eliminating one or more variables that have a low contribution to the target variable prediction to reduce dimensionality and identify remaining predictor variables. In some embodiments, feature engineering 610 computes correlation coefficients for the variables and selects the variables having a high correlation (either positive or negative) to the target variable.

In one aspect, the ML training component 154 performs exploratory data analysis 620 on the training dataset 520A. Exploratory data analysis 620 may include making and/or refining assumptions and hypotheses about the variables themselves, correlations between the variables, and/or their relationship to the target variable. Some embodiments of the exploratory data analysis 620 involve similarity search techniques that calculate Manhattan distance among vectorized data objects. The assumptions and hypotheses may include the distribution type, e.g., normal, uniform, etc., mean or median, and variance of an unknown, such as β, ε, and σ. For example, the assumptions and hypotheses may include the average number of coverage providers associated with a member in a lifetime, renewal rates for members, number of coverage providers a medical provider partners with, number of coverage providers associated with a member at any given time, etc. These assumptions provide informative priors based on domain knowledge. Exploratory data analysis 620 may include resampling the training dataset 520A to mitigate overfitting and/or underfitting.

In one aspect, the ML training component 154 estimates the posterior distribution 630 of parameters. Estimating the posterior distribution 630 may include running MCMC simulations to obtain posterior samples from the joint posterior distribution. The posterior samples represent uncertainty in the parameter estimates and may be used to calculate point estimates and/or credible intervals for one or more of the coefficients. These coefficients are used to build the coverage provider ranking ML component 160.

In one aspect, the ML training component 154 generates a posterior predictive distribution 640 for the test dataset 520B. The posterior predictive distribution 640 may be analyzed using a metric such as the Watanabe-Akaike Information Criterion (WAIC), to verify that the coverage provider ranking ML component 160 is not overfit on the training dataset 520A.

In one aspect, the ML training component 154 updates the priors 650 with new member enrollment data 550C. When new members enroll with the coverage provider, new member enrollment data 550C is generated. This new member enrollment data 550C may comprise demographics, plan details, eligibility, and/or enrollment with multiple coverage providers, including a ranking of the coverage providers. The new member enrollment data 550C may be used by the ML training component 154 to update the posterior distribution of the coverage provider ranking ML component 160. In particular, the ML training component 154 may update the prior distribution of the coverage provider ranking ML component 160 with the new member enrollment data 550C.

### Example ML Operating Data Flow for Coverage Provider Ranking Prediction

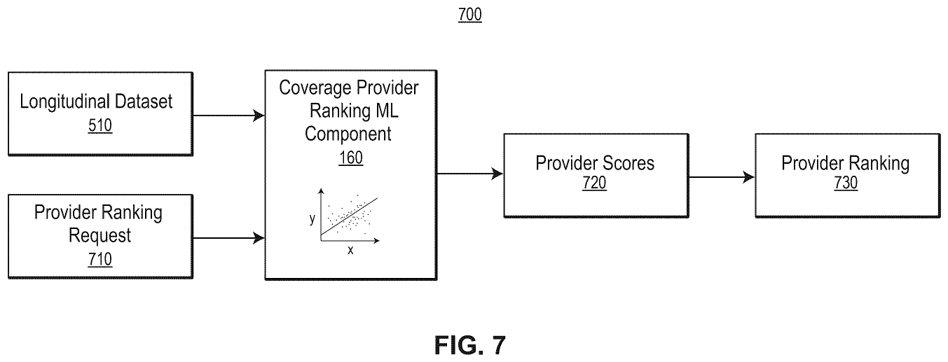

FIG. 7 depicts an example ML operation data flow 700 in which coverage provider ranking ML component 160 may generate coverage provider ranking predictions. Although FIG. 7 depicts certain entities, components, equipment, and devices, it should be appreciated that additional or alternate entities, components, equipment, and devices are also possible. ML components, such as the ML operation component 156, may include one or more hardware and/or software components to obtain and/or generate a number of features.

The ML operation component 156 provides input data to the coverage provider ranking ML component 160. The input data may include the longitudinal dataset 510 and a provider ranking request 710. The provider ranking request 710 may include a procedure code or other data indicative of a condition or procedure.

The coverage provider ranking ML component 160 may use the input data to estimate a posterior probability distribution of provider scores 720 for the plurality of coverage providers. For example, the provider scores 720 may be on a scale of 0 to 1, with higher scores indicating a greater likelihood of the coverage provider being a primary coverage provider and lower scores indicating a greater likelihood of the coverage provider being a secondary, tertiary, etc. coverage provider. The provider scores 720 may include a range of likely scores having a given, e.g., 95%, credible interval.

The request-response component 150 may generate a provider ranking 730 from the provider scores and provide the request-response component 150 to the application server 120.

### Example Method for Coverage Provider Ranking Prediction

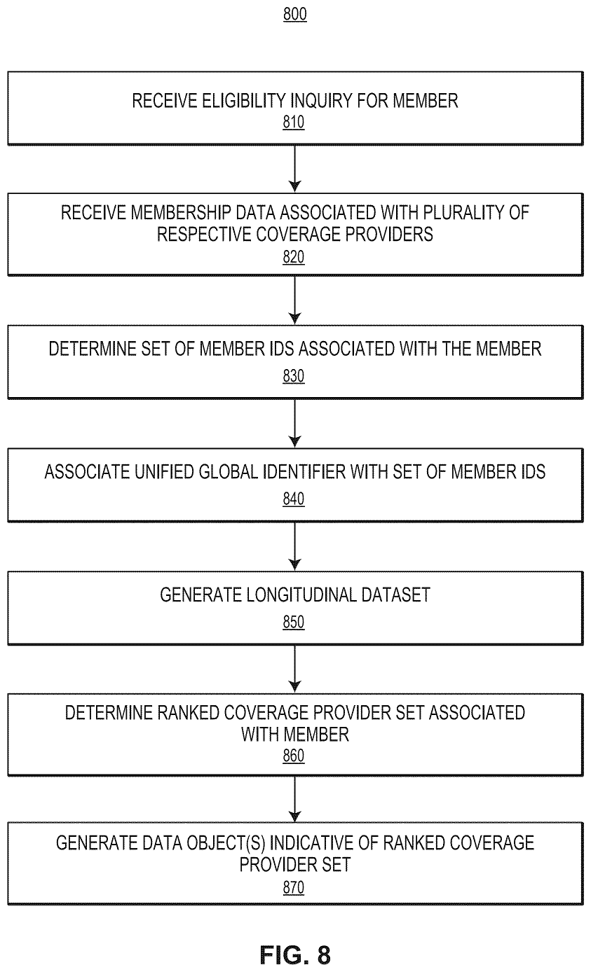

FIG. 8 depicts a flow diagram of an exemplary method 800 for generating coverage provider rankings for a member. One or more (e.g., all) steps of the method 800 are implemented as a set of instructions stored on one or more non-transitory, computer-readable memories/media and executable on one or more processors. In some embodiments, the computer-implemented method 800 of FIG. 8 is implemented by a system, such as the eligibility server 140. The method 800 may operate in conjunction with one or more of the scenarios and/or environments illustrated in FIGS. 1-7 and/or in other environments. In some embodiments, for example, the method 800 is repeated as necessary, such as when a member submits a new eligibility request.

As illustrated in FIG. 8, the example method 800 includes at block 810 receiving an eligibility inquiry for a member. In some embodiments, the member is associated with multiple coverage providers. The request-response component 150 may receive the eligibility inquiry from the client device 110 or the application server 120. The eligibility inquiry may be submitted by a member, medical provider, or coverage provider. As used herein, the term “eligibility inquiry” may include a computational data query initiating a search for associations between certain individual data objects or categories of data objects and other individual data objects or categories of data objects. For example, a query may initiate a search for all data objects corresponding to coverage providers that are associated with a data object corresponding to a particular member identifier. By way of further example, a query may initiate a search for all data objects corresponding to member identifiers that are associated with a data object corresponding to a particular coverage provider. Additionally and optionally, the query may search for a particular type of association. For example, the query may specify that an association between a member identifier and coverage provider identifier be of a type indicting that the member is currently covered by a coverage provider or eligible to be treated by a coverage provider.

The example method 800 includes at block 820 receiving membership data (e.g., member claims data 210A, member eligibility data 210B, and/or member other data 210C). In some embodiments, the membership data is associated with a plurality of respective coverage providers. In some embodiments, the membership data comprises a plurality of member identifiers associated with respective members and/or membership information associated with the plurality of member identifiers. In some embodiments, the membership information includes member claims data and/or member eligibility data associated with one or more members. The data collection and processing component 152 may retrieve the membership data from one or more data sources (e.g., the system database 162, internal data source 170, and the third-party data source 180). In some embodiments, the data collection and processing component 152 transforms a non-numerical variable in the membership information into a numerical variable, e.g., using one-hot encoding.

The example method 800 includes at block 830 determining a set of member identifiers, among the plurality of member identifiers, that are associated with the member. In some embodiments, the member ID unification ML component 158 may determine the set of member identifiers using the membership data as input. In some embodiments, the member ID unification ML component 158 includes a decision tree structure.

The example method 800 includes at block 840 associating a unified global identifier with the set of member identifiers. Associating the unified global identifier with the set of member identifiers may include linking the unified global identifier to the set of member identifiers for a member in any suitable manner. For example, associating the unified global identifier with the set of member identifiers may include joining one or more records together based on the set of member identifiers. The member ID unification ML component 158 may output one or more records including the unified global identifier and the set of member identifiers for a member (e.g., member eligibility lifecycle table 430).

The example method 800 includes at block 850 generating a longitudinal dataset (e.g., longitudinal data set 510). The data collection and processing component 152 may generate the longitudinal dataset. In some embodiments, the longitudinal dataset may be associated with the unified global identifier. In some embodiments, the longitudinal dataset may include a portion the membership information, such as member claims data and member eligibility data, associated with the set of member identifiers.

The example method 800 includes at block 860 determining a ranked coverage provider set (e.g., provider ranking 730) associated with the member. The coverage provider ranking ML component 160 may determine the ranked coverage provider set using the longitudinal dataset as input. In some embodiments, the data collection and processing component 152 determines one or more variables in the longitudinal dataset having a low predictive contribution to the one or more coverage provider scores and removes the one or more variables from the longitudinal dataset. In some embodiments, the coverage provider ranking ML component 160 includes a Bayesian linear regression and/or Bayesian Neural Network component. In some embodiments, the method 800 includes inputting a prior distribution hypothesis about one or more variables in the longitudinal dataset into the Bayesian linear regression and/or Bayesian Neural Network component. In some embodiments, the method 800 includes updating the prior distribution hypothesis with new member enrollment data. In some embodiments, the Bayesian linear regression and/or Bayesian Neural Network component determines a posterior predictive distribution of a plurality of coverage provider scores. In some embodiments, the plurality of coverage providers are ranked by the plurality of coverage provider scores.

The example method 800 includes at block 870 generating one or more data objects indicative of the ranked coverage provider set. Generating a data object may include creating a new data object or updating an existing data object. The data object may include structured data (e.g., a table with fields) and/or unstructured data. The request-response component 150 may generate the data objects.

The example method 800 may include additional blocks, such as causing a representation of the data objects to be displayed on client device 110.

It should be understood that not all blocks of the method 800 are required to be performed. Moreover, the method 800 is not mutually exclusive (i.e., block(s) from method 800 may be performed in any particular implementation). Further, in some embodiments, the operations of the method 800 are not performed strictly in the order shown in FIG. 8.

### EXAMPLES

### Example 1

A method comprising: receiving, by one or more processors, an eligibility inquiry for a member, wherein the member is associated with multiple coverage providers; receiving, by the one or more processors, membership data associated with a plurality of respective coverage providers, the membership data comprising (i) a plurality of member identifiers associated with a plurality of respective members and (ii) membership information associated with the plurality of member identifiers; determining, by the one or more processors inputting the membership data into a member identity unification machine learning (ML) component, a set of member identifiers, among the plurality of member identifiers, that are associated with the member; associating, by the one or more processors, a unified global identifier with the set of member identifiers; generating, by the one or more processors, a longitudinal dataset, associated with the unified global identifier, comprising a portion of the membership information that is associated with the set of member identifiers; determining, by the one or more processors inputting the longitudinal dataset into a coverage provider ranking ML component, a ranked coverage provider set associated with the member; and generating, by the one or more processors, one or more data objects indicative of the ranked coverage provider set.

### Example 2

The method of Example 1, wherein the membership information comprises member claims data and member eligibility data associated with a plurality of members.

### Example 3

The method of Example 1 or Example 2, further comprising: prior to determining the set of member identifiers that are associated with the member, transforming, by the one or more processors, a non-numerical variable in the membership information into a numerical variable.

### Example 4

The method of any one of Example 1 through Example 3, wherein the member identity unification ML component comprises a tree structure.

### Example 5

The method of any one of Example 1 through Example 4, wherein the longitudinal dataset comprises member claims data and member eligibility data associated with the member.

### Example 6

The method of any one of Example 1 through Example 5, wherein the coverage provider ranking ML component comprises a Bayesian linear regression and/or Bayesian Neural Network component.

### Example 7

The method of Example 6, wherein determining the ranked coverage provider set associated with the member comprises: determining, using the Bayesian linear regression and/or Bayesian Neural Network component, a posterior predictive distribution of a plurality of coverage provider scores; and ranking the multiple coverage providers by the plurality of coverage provider scores.

### Example 8

The method of Example 7, further comprising: determining, by the one or more processors, one or more variables in the longitudinal dataset having a low predictive contribution to the one or more coverage provider scores; and removing, by the one or more processors, the one or more variables from the longitudinal dataset.

### Example 9

The method of any one of Example 6 through Example 8, wherein determining the ranked coverage provider set associated with the member further comprises: inputting a prior distribution hypothesis about one or more variables in the longitudinal dataset into the Bayesian linear regression and/or Bayesian Neural Network component.

### Example 10

The method of any one of Example 6 through Example 9, further comprising: updating, by the one or more processors, the prior distribution hypothesis using new member enrollment data.

### Example 11

A system comprising one or more processors and at least one memory storing processor-executable instructions that, when executed by the one or more processors, cause the one or more processors to perform operations comprising the method of any one of any one of Examples 1 through 10.

### Example 12

One or more non-transitory computer-readable storage media storing processor-executable instructions that, when executed by one or more processors, cause the one or more processors to perform the method of any one of Examples 1 through 10.

### Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned component”, equivalent terms (e.g., “machine learning component,” “machine-learning component,” “machine-learned component”, “artificial intelligence”, “artificial intelligence component”), or species thereof (e.g., “a large language component”, “a neural network”) may include a single machine-learned component or multiple machine-learned components, such as a pipeline comprising two or more machine-learned components arranged in series and/or parallel, an agentic framework of machine-learned components, or the like.

An “artificial intelligence” or “artificial intelligence component” may comprise a machine-learned component. A machine-learned component may comprise a hardware and/or software architecture having structural hyperparameters defining the component's architecture and/or one or more parameters (e.g., coefficient(s), weight(s), bias(es), activation function(s) and/or action function type(s) in examples where the activation function and/or function type is determined as part of training, clustering centroid(s)/medoid(s), partition(s), number of trees, tree depth, split parameters) determined as a result of training the machine-learned component based at least in part on training hyperparameters (e.g., for supervised, semi-supervised, and reinforcement learning components) and/or by iteratively operating the machine-learned component according to the training hyperparameters(e.g., for unsupervised machine-learned components).

In some examples, structural hyperparameter(s) may define component(s) of the component's architecture and/or their configuration/order, such as, for example, the configuration/order specifying which input(s) are provided to one component and which output(s) of that component are provided as input to other component(s) of the machine-learned component; a number, type, and/or configuration of component(s) per layer; a number of layers of the component; a number and/or type of input nodes in an input layer of the component; a number and/or type of nodes in a layer; a number and/or type of output nodes of an output layer of the component; component dimension (e.g., input size versus output size); a number of trees; a maximum tree depth; node split parameters; minimum number of samples in a leaf node of a tree; and/or the like. The component(s) of the component may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of component architectures, such as a transformer-based machine-learned component (e.g., encoder-only component(s), encoder-decoder component(s), decoder-only components, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned component comprises may vary depending on the type of machine-learned component.

Training hyperparameter(s) may be used as part of training or otherwise determining the machine-learned component. In some examples, the training hyperparameter(s), in addition to the training data and/or input data, may affect determining the parameter(s) of the target machine-learned component. Using a different set of training hyperparameters to train two machine-learned components that have the same architecture (i.e., the same structural hyperparameters) and using the same training data may result in the parameters of the first machine-learned component differing from the parameters of the second machine-learned component. Despite having the same architecture and having been trained using the same training data, such machine-learned components may generate different outputs from each other, given the same input data. Accordingly, accuracy, precision, recall, and/or bias may vary between such machine-learned components.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned component that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned component to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned component. The machine-learned component may include any type of component configured, trained, and/or the like to generate a prediction output for a component input. In some examples, any of the logic, component(s), routines, and/or the like discussed herein may be implemented as a machine-learned component.

The machine-learned component may include one or more of any type of machine-learned component including one or more supervised, unsupervised, semi-supervised, and/or reinforcement learning components. Training a machine-learned component may comprise altering one or more parameters of the machine-learned component (e.g., using a loss optimization algorithm) to reduce a loss. Depending on whether the machine-learned component is supervised, semi-supervised, unsupervised, etc. this loss may be determined based at least in part on a difference between an output generated by the component and ground truth data (e.g., a label, an indication of an outcome that resulted from a system using the output), a cost function, a fit of the parameter(s) to a set of data, a fit of an output to a set of data, and/or the like. In some examples, determining an output by a machine-learned component may comprise executing a set of inference operations executed by the machine-learned component according to the target machine-learned component's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A method comprising:
receiving, by one or more processors, an eligibility inquiry for a member, wherein the member is associated with multiple coverage providers;
receiving, by the one or more processors, membership data associated with a plurality of respective coverage providers, the membership data comprising (i) a plurality of member identifiers associated with a plurality of respective members and (ii) membership information associated with the plurality of member identifiers;
determining, by the one or more processors inputting the membership data into a member identity unification machine learning (ML) component, a set of member identifiers, among the plurality of member identifiers, that are associated with the member;
associating, by the one or more processors, a unified global identifier with the set of member identifiers;
generating, by the one or more processors, a longitudinal dataset, associated with the unified global identifier, comprising a portion of the membership information that is associated with the set of member identifiers;
determining, by the one or more processors inputting the longitudinal dataset into a coverage provider ranking ML component, a ranked coverage provider set associated with the member; and
generating, by the one or more processors, one or more data objects indicative of the ranked coverage provider set.

2. The method of claim 1, wherein the membership information comprises member claims data and member eligibility data associated with a plurality of members.

3. The method of claim 1, further comprising:
prior to determining the set of member identifiers that are associated with the member, transforming, by the one or more processors, a non-numerical variable in the membership information into a numerical variable.

4. The method of claim 1, wherein the member identity unification ML component comprises a tree structure.

5. The method of claim 1, wherein the longitudinal dataset comprises member claims data and member eligibility data associated with the member.

6. The method of claim 1, wherein the coverage provider ranking ML component comprises a Bayesian linear regression and/or Bayesian Neural Network component.

7. The method of claim 6, wherein determining the ranked coverage provider set associated with the member comprises:
determining, using the Bayesian linear regression and/or Bayesian Neural Network component, a posterior predictive distribution of a plurality coverage provider scores; and
ranking the multiple coverage providers by the plurality of coverage provider scores.

8. The method of claim 7, further comprising:
determining, by the one or more processors, one or more variables in the longitudinal dataset having a low predictive contribution to the one or more coverage provider scores; and
removing, by the one or more processors, the one or more variables from the longitudinal dataset.

9. The method of claim 6, wherein determining the ranked coverage provider set associated with the member further comprises:
inputting a prior distribution hypothesis about one or more variables in the longitudinal dataset into the Bayesian linear regression and/or Bayesian Neural Network component.

10. The method of claim 9, further comprising:
updating, by the one or more processors, the prior distribution hypothesis using new member enrollment data.

11. A system comprising:
one or more processors; and
at least one memory storing processor-executable instructions that, when executed by the one or more processors, cause the one or more processors to perform operations comprising:
receiving an eligibility inquiry for a member, wherein the member is associated with multiple coverage providers;
receiving membership data associated with a plurality of respective coverage providers, the membership data comprising (i) a plurality of member identifiers associated with a plurality of respective members and (ii) membership information associated with the plurality of member identifiers;
determining, by inputting the membership data into a member identity unification machine learning (ML) component, a set of member identifiers, among the plurality of member identifiers, that are associated with the member;
associating a unified global identifier with the set of member identifiers;
generating a longitudinal dataset, associated with the unified global identifier, comprising a portion of the membership information that is associated with the set of member identifiers;
determining, by inputting the longitudinal dataset into a coverage provider ranking ML component, a ranked coverage provider set associated with the member; and
generating one or more data objects indicative of the ranked coverage provider set.

12. The system of claim 11, wherein the membership information comprises member claims data and member eligibility data associated with a plurality of members.

13. The system of claim 11, wherein the processor-executable instructions further cause the one or more processors to perform operations comprising:
prior to determining the set of member identifiers that are associated with the member, transforming a non-numerical variable in the membership data into a numerical variable.

14. The system of claim 11, wherein the member identity unification ML component comprises a tree structure.

15. The system of claim 11, wherein the longitudinal dataset comprises member claims data and member eligibility data associated with the member.

16. The system of claim 11, wherein the coverage provider ranking ML component comprises a Bayesian linear regression and/or Bayesian Neural Network component.

17. The system of claim 16, wherein determining the ranked coverage provider set associated with the member comprises:
determining, using the Bayesian linear regression and/or Bayesian Neural Network component, a posterior predictive distribution of a plurality of coverage provider scores; and
ranking the plurality coverage providers by the plurality of coverage provider scores.

18. The system of claim 17, wherein the processor-executable instructions further cause the one or more processors to perform operations comprising:
determining one or more variables in the longitudinal dataset having a low predictive contribution to the one or more coverage provider scores; and
removing the one or more variables from the longitudinal dataset.

19. The system of claim 16, wherein determining the ranked coverage provider set associated with the member further comprises:
inputting a prior distribution hypothesis about one or more variables in the longitudinal dataset into the Bayesian linear regression and/or Bayesian Neural Network component.

20. The system of claim 19, wherein the processor-executable instructions further cause the one or more processors to perform operations comprising:
updating the prior distribution hypothesis with new member enrollment data.
